(19) United States
(12) Patent Application Publication
(10) Pub. No.: US 2008/0103960 A1
(43) Pub. Date: May 1, 2008

(54) System and method for a website that provides homeowners with a web based tool for debt consolidation options

(75) Inventor: Michael John Sweeney, Highlands Ranch, CO (US)

Correspondence Address: Mortgage Innovations, Inc.;DBA LionSaves.com, 6909 S. Holly Circle #280, Centennial, CO, 80112, US

(73) Assignee: Mortgage Innovations, Inc. DBA LionSaves.com

(21) Appl. No.: 11/553,807

(22) Filed: Oct. 27, 2006

(51) Int. Cl. G06Q 40/00

(52) U.S. Cl. 705/38

(57) ABSTRACT

A system and method for a website, in the field of mortgage originating, which is a web based tool homeowners can access, free of charge, and enter their personal debt information and real property information. The website then calculates the data and provides the homeowner with a plurality of personalized mortgage debt consolidation options anonymously. The homeowner is not required to give any contact information nor is the homeowner required to talk with any salespeople to obtain their personalized debt consolidation options.

### CROSS-REFERENCE TO RELATED APPLICATIONS

U.S. Pat. Nos. 6,901,384; 6,823,319; 7,089,202; 6,385,594; 6,611,816; 6,064,986; 6,049,784; 6,029,149; 6,014,645; 5,995,947; 5,966,699; 5,940,812; 5,930,776; 5,924,082; 5,907,828; 5,878,403; 5,870,721; 5,845,265; 5,797,133; 5,794,207; 5,754,850; 5,708,825; 5,706,434; 5,701,451; 5,535,407; 4,346,442

### FEDERALLY SPONSORED RESEARCH

Not Applicable

### SEQUENCE LISTING OR PROGRAM

Not Applicable

### BACKGROUND OF THE INVENTION

1. Field of Invention

This invention of a business system and method relates to a process for mortgage debt consolidation options given over the Internet in the field of Mortgage Origination.

2. Prior Art

Homeowners have used the power of mortgage refinancing to consolidate their debts and save money for years now. There can be multiple benefits to this including: lowering monthly payments, lowering averaged debt interest rate and receiving a tax benefit at the end of the year since mortgage interest, according to the IRS, is typically allowed to be used as a deduction and therefore can lower an individual's tax liability. Interest paid on homeowner debt such as credit cards, auto loans and student loans, are not allowed to be used as a deduction like mortgage interest.

Homeowners are able to obtain a mortgage through different sources such as mortgage brokers, mortgage bankers, banks, savings & loans and credit unions. Traditionally, the homeowner has been required to talk with a salesperson from one of these sources to receive possible debt consolidation options through mortgage refinancing. These salespeople are known most commonly in the industry as loan originators and loan officers. They may also carry titles such as mortgage consultant or mortgage advisor.

There are many frustrations for the homeowner that ensues from this situation. The first is these individuals are typically paid entirely on commission and commonly subscribe to sales training and tactics to increase the amount of mortgages they “sell” to increase their pay. The end result to the homeowner is often times a high pressure sales environment filled with possibly false and misleading statements to entice them towards a particular mortgage that may or may not be in the homeowner's best interest.

Secondly, this situation can also be inconvenient for the homeowner since they may only be able to receive this information during business hours and not on a day or time that works best for them. Some mortgage sources even require the homeowner to fill out a loan application and pay a fee before the homeowners can find out what, if any, options may be available to them. If the homeowner does not decide on a loan option immediately, many of these salespeople will then call the homeowner back multiple times to try and pressure them into one of their options.

Additionally, many times the homeowner likes to run different debt consolidation scenarios, which include some debts or not include others. This can be too time consuming for the salesperson to complete and so the homeowner ends up not being fully informed. Likewise, much of the information exchanged is verbal, so the homeowner may not have a clear understanding of the actual closing costs involved or the exact terms of the loan option(s) after the salesperson has been talking to them for a while. Obviously, this can lead to confusion for the homeowner and frustration at the closing table if they end up signing closing papers for a loan with different terms than they expected.

Once the Internet became a viable medium for homeowners, multiple websites started appearing that weren't a mortgage source but rather a lead generator for mortgage sources. Some examples of these websites are: LendingTree (U.S. Pat. Nos. 6,385,594 & 6,611,816), LowerMyBills.com, MortgageLeads.net, LoanApp.com and LoanWeb.com just to name just a few. The main premise of these sites is that you enter your contact information and then multiple lenders (mortgage sources) will bid for your business. These sites only collect the homeowner's contact information, they don't provide any options, and then sell that contact information off as a lead to four or more mortgage lenders who pay a substantial fee for that lead. The homeowner is then contacted multiple times via phone calls or e-mails from these lender's salespeople who begin the sales process described above. The fee paid to the lead generator must be factored in to the lender's profit margin, which of course, diminishes the lead generator's claim of getting the homeowner the best deal. A homeowner can pick up the yellow pages, call four or five different lenders and receive a loan with equal or better terms since the lead generator's fee has been removed from the equation. Some lead generators even sell the homeowner's contact information to another lead generator who then turns around and sells the information out to four or more lenders as a lead. The end result to the homeowner in this situation is a barrage of phone calls and e-mails pressuring the homeowner and resulting in the aforementioned frustrations. Homeowners have had to physically go to, call, or receive e-mails from a lender. This process is tedious and time consuming.

Other websites on the Internet have mortgage calculators offered as a tool to homeowners. These are far from being accurate and really don't provide much of a benefit to the homeowner since they typically don't include property taxes, insurance, or mortgage insurance in the estimated payment. If they do include any of these items, they are an extremely rough, very inaccurate estimate at best; at worst they give false information to the homeowner. They are also not personalized for the homeowner since the variables that affect available loan options will vary depending on such things as the location of the property, the value of the property, the amount of debts the homeowner has and the current terms of both the mortgage and the homeowner debt owed.

### OBJECTS AND ADVANTAGES

Until now, there has not been a way for homeowners to obtain accurate, instant, and personalized mortgage debt consolidation options without giving their contact information or talking with a salesperson.

This invention is a website which homeowners can access, free of charge, enter their debt information and real property information and then discover their personalized debt consolidation options. The homeowner is not required to give any contact information such as their name, an e-mail address, and property address or phone numbers. Nor is the homeowner required to talk with any salespeople to find out their personalized options.

Accordingly, the objects and advantages of my system and method are:
a. Convenience—Homeowners can access the web based tool (website) at anytime
b. Free—Homeowners can access the website and receive their debt consolidation options for free. Once they choose an option, they pay the regular & customary closing costs associated with the loan.
c. Empowerment—Being informed with their options, the homeowner will be empowered and can then decide to proceed on the website to choose one of the options or, take the information we have provided and obtain their loan from another mortgage source.
d. No Pressure—Homeowners won't have to talk to salespeople and get the high pressure “hard sell”.
e. Customized—The website will provide the homeowner with options customized for their situation based on the information they enter.
f. Anonymous—The homeowner remains anonymous until they decide to move forward with a debt consolidation option with us or they decide to contact us via phone or e-mail with questions. They won't have to provide any contact info to receive their personalized options.
g. Thoroughness—The homeowner can view all different options available and edit the information they have provided to play with different debt consolidation scenarios or view another option.
h. Consultation—The website will recommend different options for the homeowner based on what the homeowner has entered and by answering several questions.
i. Instant—the website provides these answers instantly to the homeowner to save them time.
j. Financial Control—All of the above will help the homeowner to gain financial control. In addition, the website will provide them with details on each option such as building their wealth and becoming debt free faster.
k. Risk free—all of the above allow the homeowner to obtain debt consolidation options risk free.
l. In writing—Each option prints out a report for the homeowner to see the loan terms and costs in writing before making a decision.
m. Saves Aggravation—No hassle to the homeowner.
Further objects and advantages of this invention will become apparent from a consideration of the drawings and ensuing description.

### SUMMARY

A web based tool (website) that provides homeowners, at no charge, with possible debt consolidation options anonymously.

### DRAWINGS—SEE ATTACHED

### BRIEF DESCRIPTION OF THE DRAWINGS

Other objects and features of the present invention will become apparent from the following detailed description considered in connection with the accompanying drawings, which disclose several embodiments of the present invention. It should be understood, however, that the drawings are designed for the purpose of illustration only and not as a definition of the limits of the invention.

In the drawings, wherein similar reference characters denote similar elements throughout the several views:

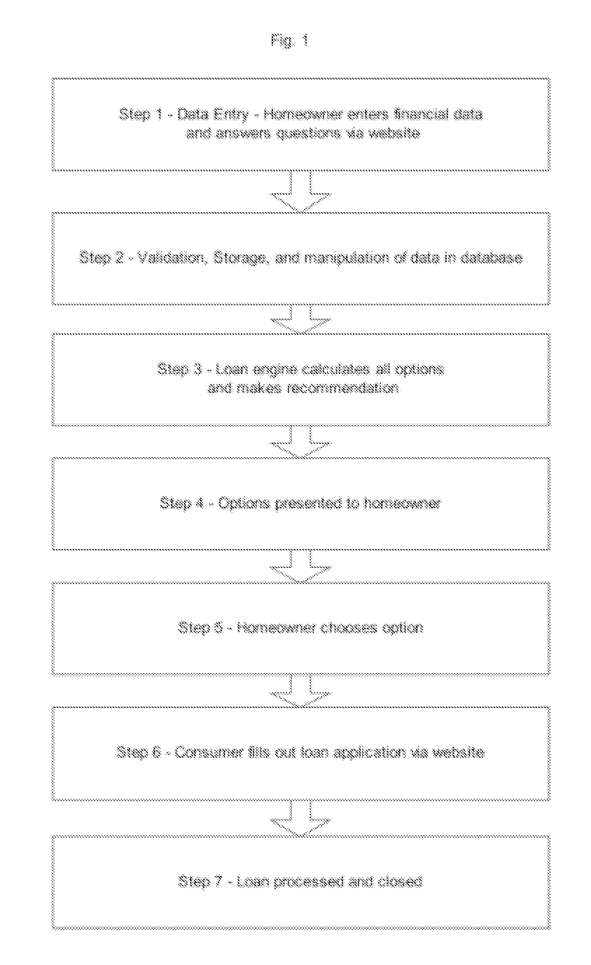

FIG. 1—shows an overview of the method of the invention

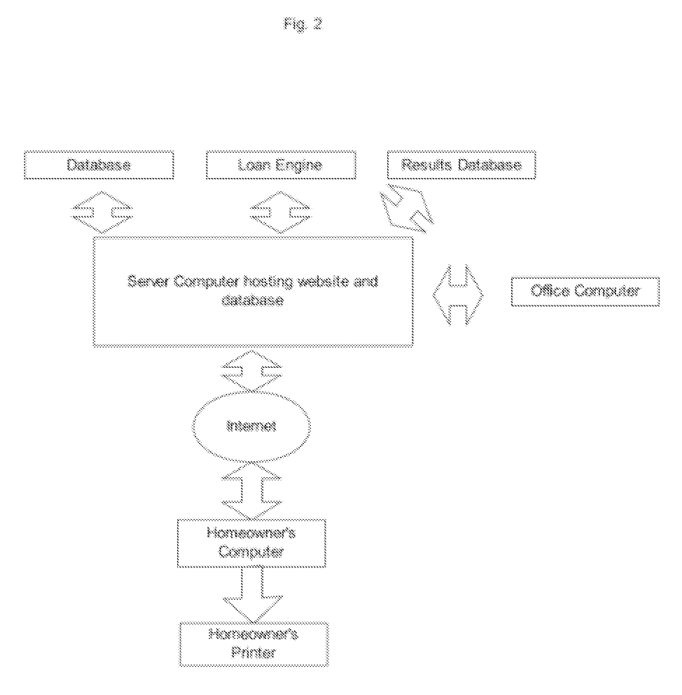

FIG. 2—schematic depiction of the network designed to achieve the method of the invention

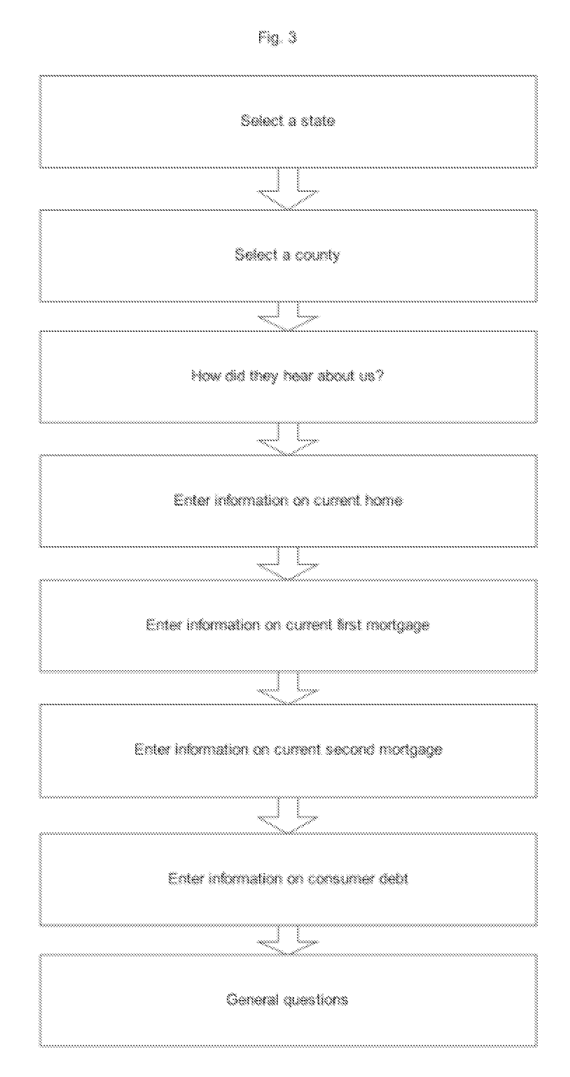

FIG. 3—shows the steps involved in the data entry process of FIG. 1, step 1

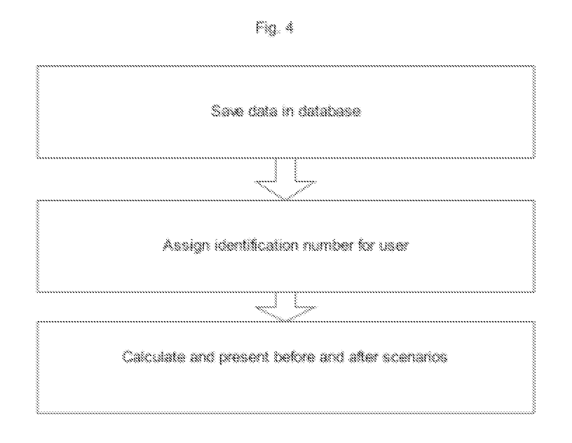

FIG. 4—shows the steps of FIG. 1, step 2

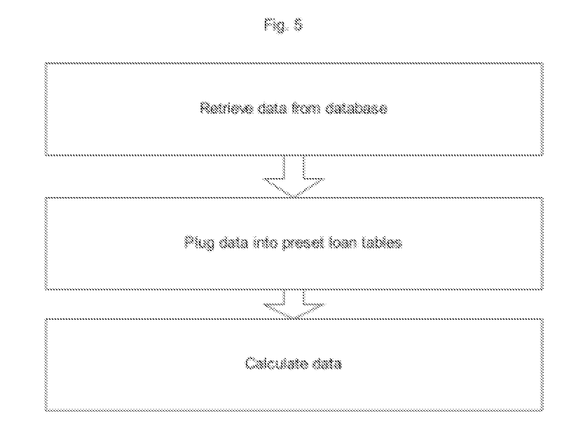

FIG. 5—shows the steps of FIG. 1, step 3

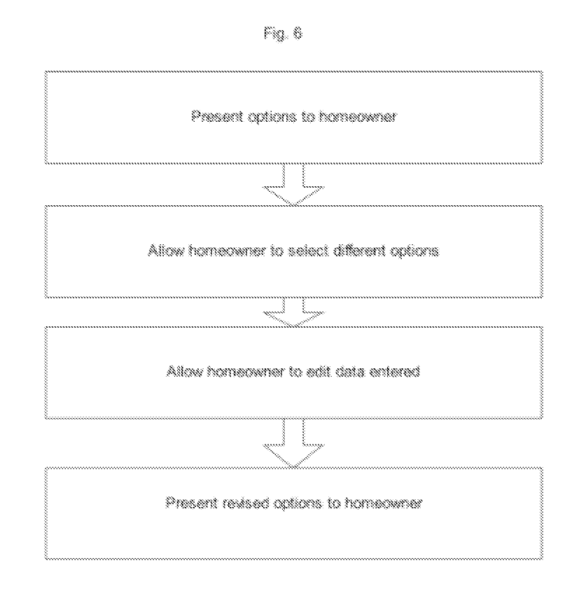

FIG. 6—shows the steps of FIG. 1, step 4

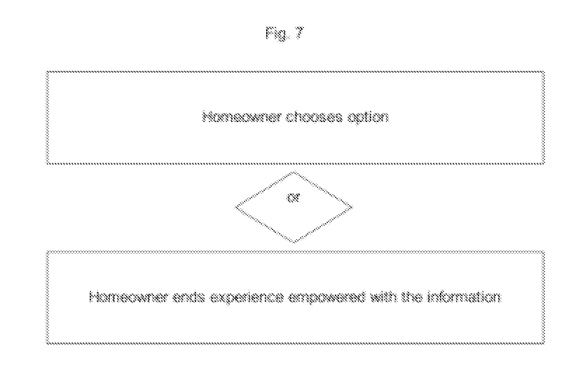

FIG. 7—shows the steps of FIG. 1, step 5

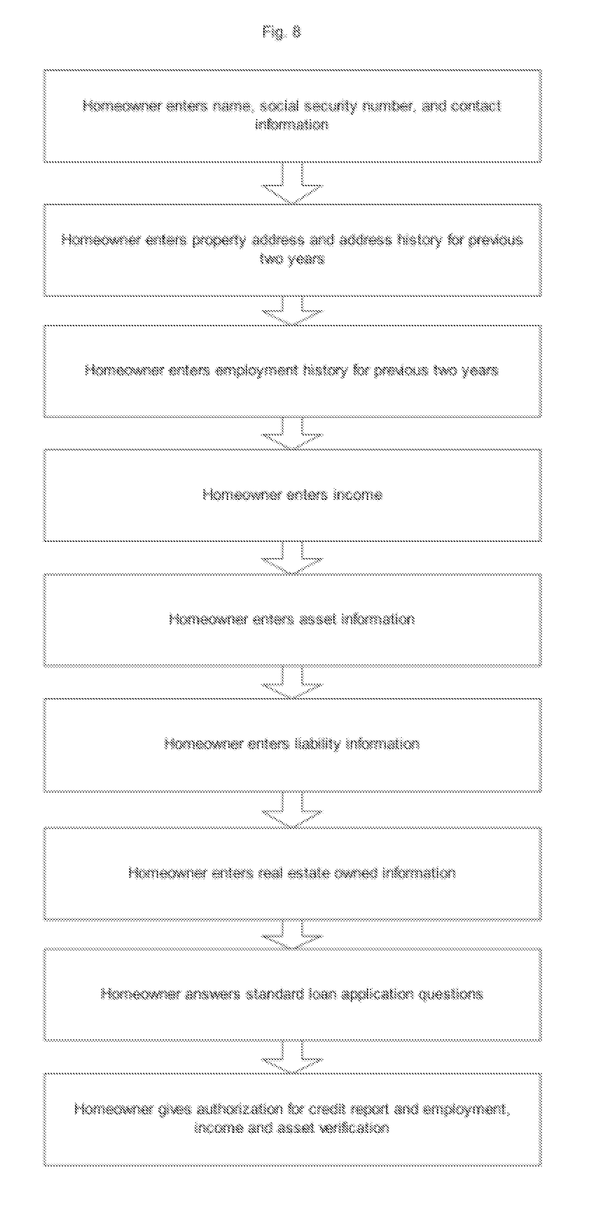

FIG. 8—shows the steps of FIG. 1, step 6

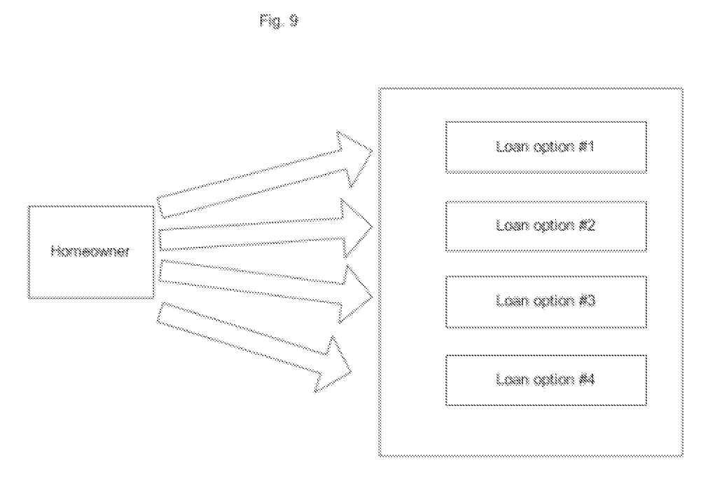

FIG. 9—shows where a homeowner can pick from a plurality of loan options

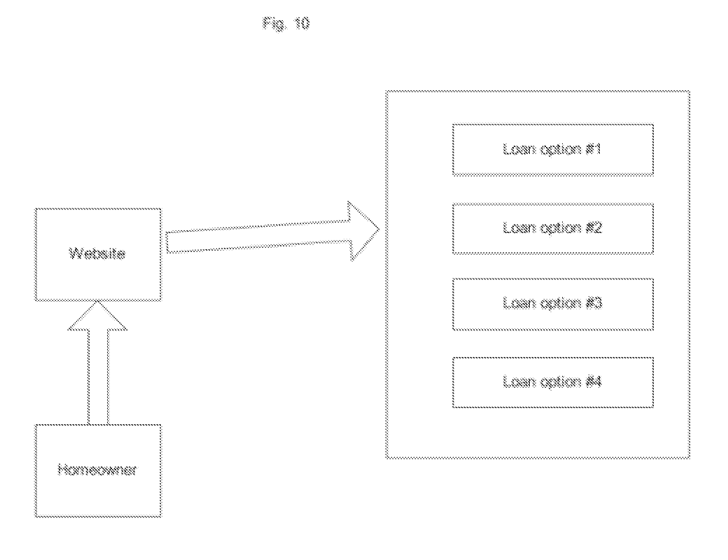

FIG. 10—shows where website makes recommendation to homeowner based on answers to questions and available loan options

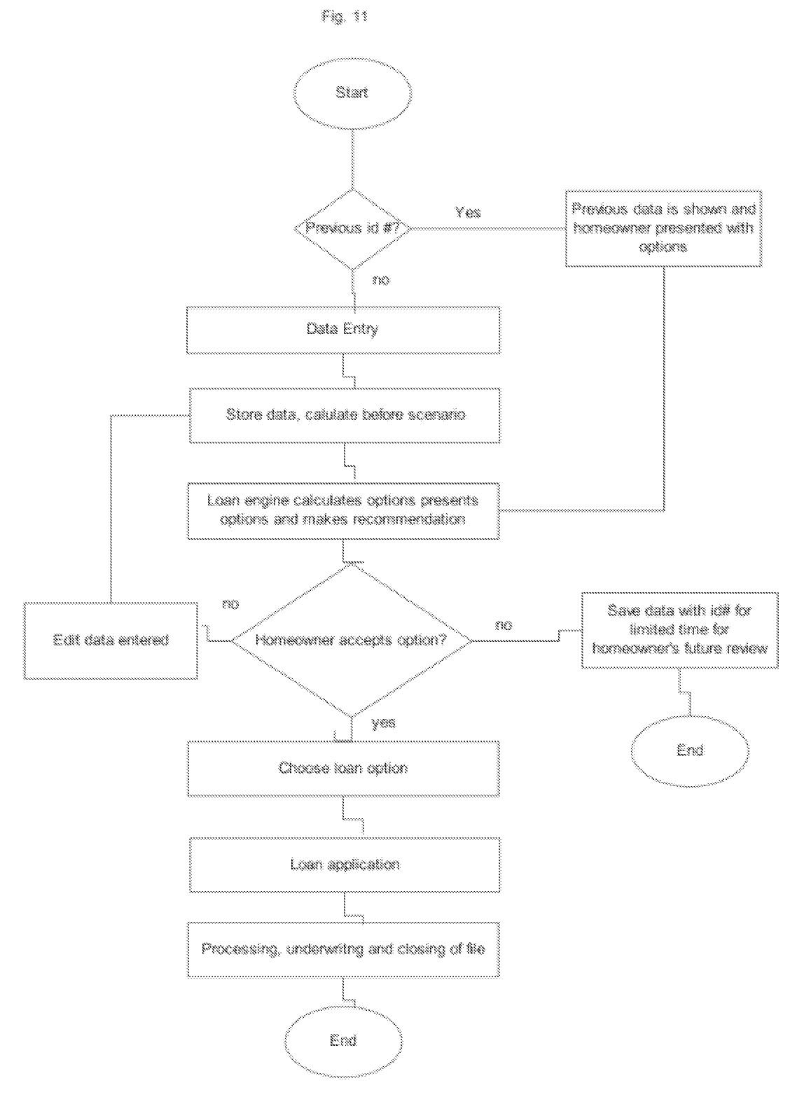

FIG. 11—shows flowchart overview of the method of the invention

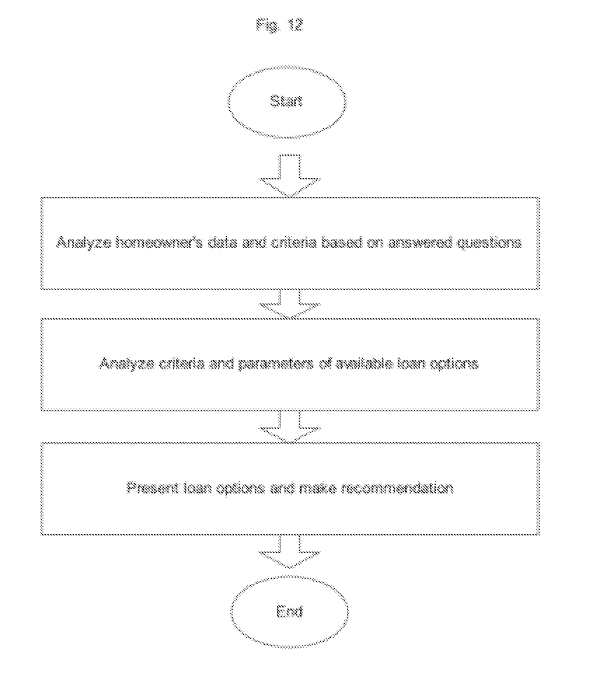

FIG. 12—shows flowchart overview of the loan engine

### DETAILED DESCRIPTION OF THE PREFERRED EMBODIMENTS

Essentially, the invention is a process and a computer for providing a web based tool to homeowners, at no charge and without giving any contact information, that will inform the homeowner of the possible mortgage debt consolidation options that may be available based on their situation.

FIG. 1 illustrates the seven general steps in the process required to coordinate the presentation of a plurality of mortgage loan options to the homeowner and to then allow the homeowner to choose an option and have the loan processed and closed.

In step 1, the process asks for data entry from the homeowner on a web site. The prospective borrower inputs information onto the web site. In step 2, validation checks are performed on this information to make sure that the information is entered correctly.

Next, the data is stored in the database for manipulation and calculation. Step 3 involves calculations of the entered data and calculations of available loan options. Next, in step 4, the available loan options are presented to the homeowner. At this point, the website will make a recommendation of an available loan option based on the homeowner's needs and the parameters of the available loan options. The available loan options also are provided with a good faith estimate. The homeowner can then edit or change the data they have entered to see how that affects their loan options, they can make not of their assigned identification number so they can come back to the website at a later time to review and/or make changes to their data, they can close their internet browser and be done with the website completely, or they can choose an available loan option (step 5). Step 6 consists of the homeowner now giving their contact information including: name, address, phone number, e-mail address, social security number, employment information and income. This and other information is collected on a standard mortgage loan application, also known as a Fannie Mae form 1003. Step 7 consists of the loan option then being processed and closed. This includes verification of all data entered by homeowner and confirmation on whether or not homeowner will qualify for chosen option based on these confirmations. If homeowner's credit score is not high enough to qualify, then there is no charge to homeowner for the credit report.

For this process to occur, there must be a series of computers connected to each other via telecommunication lines as shown in FIG. 2. Here, the website's computer program controls the process and is housed on server computer. The software that resides on the server computer gives instructions to the homeowner's computer. Some of the calculations for the method and process are performed on the server computer and some on the homeowner's computer. The homeowner's computer will access the website through the Internet via a web browser such as Netscape, Internet Explorer, or Mozilla Firefox installed on the homeowner's computer.

The database software being used on the server computer is MySql and the interface software being used between the server computer and the homeowner's computer will include: PHP, AJAX, and Java. All of these components are being assembled by software titled Macromedia Dreamweaver 8.0. In the future, other software may be employed as new software is released.

The homeowner's computer must have sufficient memory and processor power to project the program over the Internet and for their local web browser and computer to calculate the data. Therefore, the recommended minimum requirements for the homeowner's computer are an Intel Pentium 400 Mhz processor. The remaining standard components are 128 megabytes of ram, 8 gigabytes of disk space, an Internet connection, and preferably at least a Windows 2000 or Windows XP operating system. The homeowner's computer must also have access to the Internet via a LAN, phone/dsl line or cable. A Wi-Fi or Wi-Max may also be used.

FIG. 3 shows the steps involved in the data entry process of the invention. The homeowner selects a state and county their property is located in, how the heard about the website. Then they enter the information on their current home such as property value, length of ownership, amount of property taxes, and amount of homeowner's insurance. Then they enter the information on their first mortgage such as the loan amount, the current interest rate, the payment, and the mortgage insurance payment, if applicable. Next, they enter their information on their current second mortgage or home equity line of credit, if applicable, such as current interest rate and payment. Next, if applicable, they enter the information on their homeowner debt (i.e. credit cards, student loans, auto loans, or any personal lines of credit) such as interest rates, loan balances, and payments. Finally, they are asked a few general questions that will help determine the best recommendation based on their preferences. Some examples of these questions are: How long will you be keeping this property? Do you prefer an adjustable interest rate or a fixed interest rate mortgage? All of this data is entered without the homeowner having to enter any personal contact info such as name, address, e-mail address or phone numbers.

FIG. 4 illustrates how the data is saved in the database of the server computer. Once the data is saved, the homeowner is assigned a personal identification number linked to this data. This way, the homeowner won't have to re-enter their information if they decide they would like to come back to the website at a later date to review or edit the data they've entered. Upon returning to the website, the homeowner may sign in with their identification number and pick up right where they left off upon exiting.

Once the data is entered and saved in the server computer, (FIG. 5 & FIG. 6) a plurality of calculations will be performed by the program to calculate the current or before scenario and to calculate the data on the available loan options, the guideline parameters of these options, and then be able to make a recommendation to the homeowner (FIG. 10 & 12). It will also show all options to the homeowner in case the homeowner does not prefer the recommended option. At this point, the homeowner may also edit or correct the aforementioned data they've entered to then recalculate and see how the options are affected. Those skilled in the art will be familiar with the parameters and requirements of various mortgage loan options such as FHA, Fannie Mae, Freddie Mac, and other private institutions offering a plurality of both first and second mortgage programs.

There will be a plurality of options (FIG. 9) that will also contain a plurality of useful information for the homeowner such as: financing structure of option, new loan balance(s), monthly payment(s), debts consolidated, averaged debt interest rate on all debt before and after, estimated monthly savings in the difference of the payment(s) every month, year, five years, ten years, fifteen years, twenty years, and thirty years, estimated income tax benefit by month and year, percent in savings on the monthly payment(s), closing costs, the payback period of the option (which is closing costs/monthly savings), if additional cash back is available under the option, an illustration of using the savings to improve finances by show how the homeowner can apply savings towards overall debt and be debt free in so many years or by taking the saving and reinvesting at a given interest rate and how the homeowner can then build their wealth.

FIG. 7 illustrates step 5 from FIG. 1. The homeowner will now make a decision. They can choose one of the presented options and move forward with applying for and the processing of that option. They may exit their web browser, end the session and then come back at a later time with their identification number to review or edit their data. Or, they may choose to close their browser and end their session completely, upon doing this; the homeowner will at least be empowered with the information presented to them at no charge.

FIG. 11 shows the overview of the process in a flowchart structure.

### CONCLUSION, RAMIFICATIONS, AND SCOPE

Accordingly, the reader will see that the benefits of this web-based tool (website) are enormous to the homeowner. The homeowner can get their customized information they need on the available mortgage debt consolidation options anytime day or night without having to talk to a pushy salesperson or pay any fee for this information. They can be empowered with all of this information without having to give any of their personal contact information. They can print these options to review later, possibly with their spouse, and make an informed decision. They will be provided with an identification number so after entering their information, they can come back at a later time to access the website and enter new data, try different scenarios or review by themselves or with their spouse.

Although the description above contains many specificities, these should not be construed as limiting the scope of the invention but as merely providing an illustration of the presently preferred embodiment of this method and system. A preferred embodiment will always be based on the needs and/or the preferences of the homeowner. While several embodiments of the present invention have been shown and described, it is to be understood that many changes and modifications may be made thereunto without departing from the spirit and scope of the invention as defined in the appended claims.

What is claimed is:

1. A method for presenting a plurality of mortgage options via a dynamic website, comprising:
a. data entered from a homeowner,
b. said data is stored in a database,
c. said dynamic website displays a plurality of mortgage options to said homeowner,
d. said dynamic website allows said homeowner to choose one of said mortgage options,
e. said dynamic website allows said homeowner to edit said data to calculate a new plurality of mortgage options,
f. said dynamic website does not require any contact information from said homeowner to enter said data and receive said plurality of mortgage options,
g. said homeowner does not have to communicate with anyone to enter said data and receive said plurality of mortgage options,
whereby said dynamic website becomes a tool for said homeowner to access, free of charge and anonymously, and be presented with said mortgage options to inform said homeowner of possible savings to consolidate their debts.

2. A website with the computing means to analyze a homeowner's data and calculate a plurality of mortgage options and display corresponding detailed information of each said plurality of mortgage options, comprising:
a. compares said homeowner's data to a plurality of mortgage parameters,
b. comparing said homeowner's data entered to the criteria of said mortgage parameters and calculates said plurality of mortgage loan options,
c. displays a new mortgage payment,
d. displays estimated closing costs,
e. displays estimated escrow items,
f. displays a Good Faith Estimate,
g. displays estimated monthly savings,
h. displays a payback period which is said closing costs divided by said monthly savings,
i. displays debts consolidated,
j. displays a new averaged debt rate,
k. displays estimated income tax benefits,
l. displays a possibility of cash back to a homeowner if so possible,
m. displays said estimated monthly savings being applied towards each said plurality of mortgage options to illustrate how said homeowner could become debt free sooner,
n. displays said estimated monthly savings being invested and accruing over time,
whereby said website will inform said homeowner of possible savings and illustrate the process of wealth building and financial control to said homeowner.

3. A method of gathering information from a homeowner via a website.

4. The method in claim 3 wherein said homeowner selects a state where said homeowner's property is located.

5. The method in claim 3 wherein said homeowner selects a county where said homeowner's property is located.

6. The method in claim 3 wherein said homeowner selects how said homeowner heard about said website.

7. The method in claim 3 wherein said homeowner enters a estimated value of said homeowner's property.

8. The method in claim 3 wherein said homeowners enters a length of time said homeowner has lived in said homeowner's property.

9. The method in claim 3 wherein said homeowner enters a length of time said homeowner intends to live in said homeowner's property.

10. The method in claim 3 wherein said homeowner enters a balance of current first mortgage lien on said homeowner's property.

11. The method in claim 3 wherein said homeowner enters a total monthly mortgage payment on said current first mortgage lien.

12. The method in claim 3 wherein said homeowner enters a interest rate on said current first mortgage lien.

13. The method in claim 3 wherein said homeowner confirms a estimated principle and interest payment on said current first mortgage lien.

14. The method in claim 3 wherein said homeowner confirms a estimated hazard insurance on said homeowner's property.

15. The method in claim 3 wherein said homeowner confirms a estimated property taxes on said homeowner's property.

16. The method in claim 3 wherein said homeowner confirms a estimated mortgage insurance on said current first mortgage lien.

17. The method in claim 3 wherein said homeowner enters a balance, interest rate, and total monthly payment of current second mortgage or home equity line of credit, if applicable.

18. The method in claim 3 wherein said homeowner enters balances, interest rates, and minimum monthly payments of all of said homeowner's debt, including but not limited to auto loans, student loans, credit cards, and personal lines of credit, if applicable.

19. The method in claim 3 wherein said homeowner allows said website to estimate some of said information.

20. The method in claim 3 wherein said homeowner answers a plurality of questions.
whereby all said information is collected without said homeowner having to give any contact information including but not limited to said homeowner's name, address, e-mail address or phone numbers and also not have to communicate with anyone and thereby be presented with a plurality of mortgage options to inform said homeowner.
